(19) United States
(12) Patent Application Publication
(10) Pub. No.: US 2008/0209260 A1
(43) Pub. Date: Aug. 28, 2008

(54) APPARATUS AND METHOD FOR SYNCHRONIZING EMBEDDED DATABASES OF APPLICATIONS IN A FAILOVER CLUSTER

(76) Inventor: Venkateswara Rao Vykunta, Freemont, CA (US)

Correspondence Address: Kunzler & McKenzie, 8 EAST BROADWAY, SUITE 600, SALT LAKE CITY, UT, 84111, US

(21) Appl. No.: 11/679,737

(22) Filed: Feb. 27, 2007

(51) Int. Cl. G06F 11/14

(52) U.S. Cl. 714/6

(57) ABSTRACT

A method and computer program product in accordance with the invention includes identifying, by an application upon startup, redundant applications running in a failover cluster. Each of the application and redundant applications includes an embedded database for storing data. The application determines which embedded database of the applications contains the most recent version of data, retrieves the most recent version of data, and writes this version to its embedded database. The application then notifies the other applications and waits for the other applications to complete replication to their embedded databases. The application may then commence operation, replicate changes to its embedded database to the other applications, and generate a timestamp indicating the time the changes are made.

### BACKGROUND OF THE INVENTION

1. Field of the Invention

This invention relates to failover clusters and more particularly to apparatus and methods for synchronizing embedded databases of applications in failover clusters.

2. Description of the Related Art

Desktop and web-based applications are often designed to capture and store data in embedded databases for persistence. For example, a network management application may store changes made to a network's configuration in an embedded database integrated with the application. In general, embedded databases are software components incorporated into applications as opposed to separately running applications. Some advantages of embedded databases over conventional databases (e.g., Oracle, PostgreSQL, etc.) include their improved availability, performance, reduced cost, and ease of administration. An embedded database may also eliminate the need for an application to obtain permission to connect to a database process or to obtain a database account.

In certain cases, end user requirements may dictate that applications be available with little or no down time for the end user. One way to achieve this is by configuring these applications in a cluster of redundant servers in a failover mode of operation. If a server or application on a server fails (e.g., crashes) in this configuration, traffic intended for the failed server or application is passed to another active server running the application. Alternatively, traffic intended for the failed server or application may be passed to a redundant instance of the server which is brought online only when the primary server or application fails. These events may be configured to occur automatically without the need for administrative intervention.

Nevertheless, applications using embedded databases may be difficult to implement in failover clusters. Because of the embedded databases, data synchronization between applications in the cluster may be quite complicated. Accordingly, what are needed are apparatus and methods to accurately and reliably synchronize data in embedded databases of applications in a failover cluster.

### SUMMARY OF THE INVENTION

The present invention has been developed in response to the present state of the art, and in particular, in response to the problems and needs in the art that have not yet been fully solved by currently available apparatus and methods. Accordingly, the present invention has been developed to provide a method and computer program product for synchronizing embedded databases of applications in a failover cluster.

In a first aspect of the invention, a method in accordance with the invention includes identifying, by an application upon startup, redundant applications running in a failover cluster. Each of the application and redundant applications includes an embedded database for storing data. The application determines which embedded database of the applications contains the most recent version of data. Once determined, the application retrieves the most recent version of the data and copies this version to its embedded database. The application then notifies the redundant applications that the most recent version has been copied and waits for the redundant applications to copy the most recent version to their embedded databases.

After completing these steps, the application then commences operation by, for example, processing service requests. While operating, the application is also configured to replicate changes made to the embedded database of the application to the embedded databases of the other redundant applications. Each time this occurs, the application generates a timestamp reflecting the time the changes were made to the embedded database. This timestamp is used to determine which application stores the most recent data in the event an application unexpectedly shuts down or crashes.

In another aspect of the invention, a computer program product to synchronize embedded databases of applications in a failover cluster includes a computer-readable medium storing a computer-readable program. When executed on a computer, this program causes an application to identify, upon startup, redundant applications running in a failover cluster. The application then determines which embedded database of the applications contains the most recent version of data. Once determined, the application retrieves the most recent version of the data and copies this version to its embedded database. The application then notifies the redundant applications that the most recent version has been copied and waits for the redundant applications to do the same.

After completing these steps, the application commences operation. While operating, the application replicates changes made to the data in its embedded database to the embedded databases of the other applications. Each time this replication occurs, the application generates a timestamp reflecting the time changes are made to the embedded database.

The present invention provides a novel apparatus and method for synchronizing data in embedded databases of applications in a failover cluster. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a high-level schematic block diagram of several redundant applications running on different servers in a failover cluster;

FIG. 2 is a flow diagram illustrating one embodiment of a general process for synchronizing data in embedded databases of applications in a failover cluster; and

FIG. 3 is a flow diagram illustrating one embodiment of a more detailed process for synchronizing data in embedded databases of applications in a failover cluster.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus and methods of the present invention, as represented in the Figures, is not intended to limit the scope of the invention, as claimed, but is merely representative of selected embodiments of the invention.

One or more of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, specific details are provided, such as examples of programming, software modules, user selections, etc., to provide a thorough understanding of embodiments of the invention. One skilled in the relevant art will recognize, however, that the invention may be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

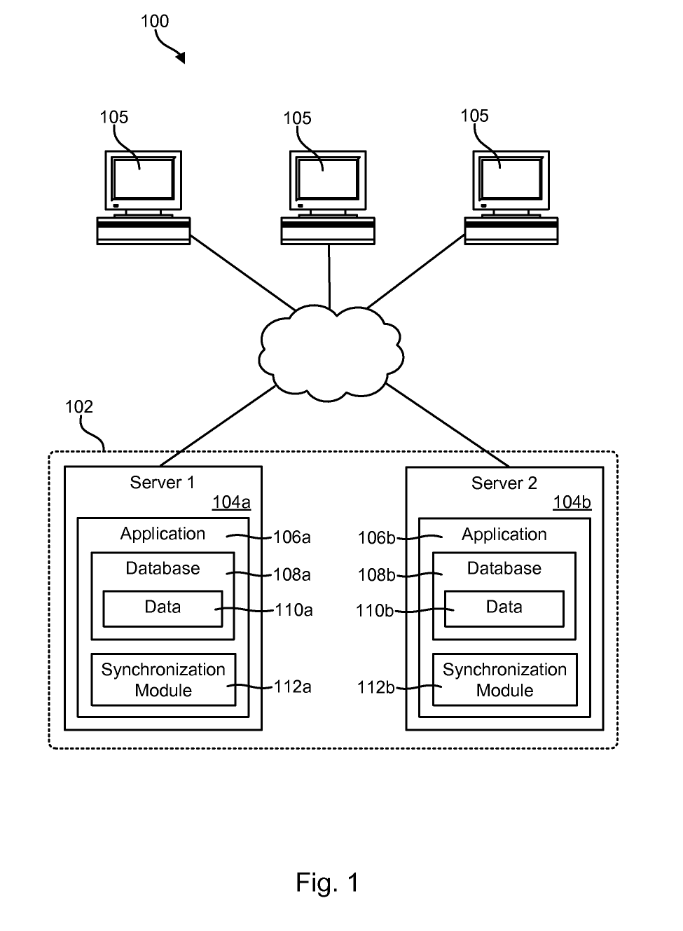

Referring to FIG. 1, in certain embodiments, a network 100 may include a failover cluster 102 to improve the availability of services provided by nodes 104a, 104b (e.g., servers 104a, 104b) in the cluster 102 to various clients 105. For example, a cluster 102 may include multiple redundant servers 104a, 104b configured to run redundant applications 106a, 106b in a failover mode of operation. In certain embodiments, traffic (e.g., service requests) intended for a failed server 104a or application 106a may be passed to another active server 104b running another instance of an application 106b in the event the first server 104a or application 106a unexpectedly fails (e.g., shuts down, crashes, etc.). Alternatively, traffic intended for a failed server 104a or application 106a may be passed to a redundant server 104b or instance of the application 106b which is brought online only when the primary server 104a or application 106a fails. In certain embodiments, the failover may be configured to occur automatically without administrative intervention.

In certain embodiments, redundant applications 106a, 106b utilizing embedded databases 108a, 108b may be configured to run on the nodes 104a, 104b in a failover mode of operation. In order to maintain data integrity and ensure that each application 104a, 104b has access to the same up-to-date data 110a, 110b, it is advantageous to synchronize the data contained in these embedded databases 108a, 108b. To accomplish this task, synchronization modules 112a, 112b in accordance with the invention may be integrated into the applications 106a, 106b or run in conjunction with the applications 106a, 106b.

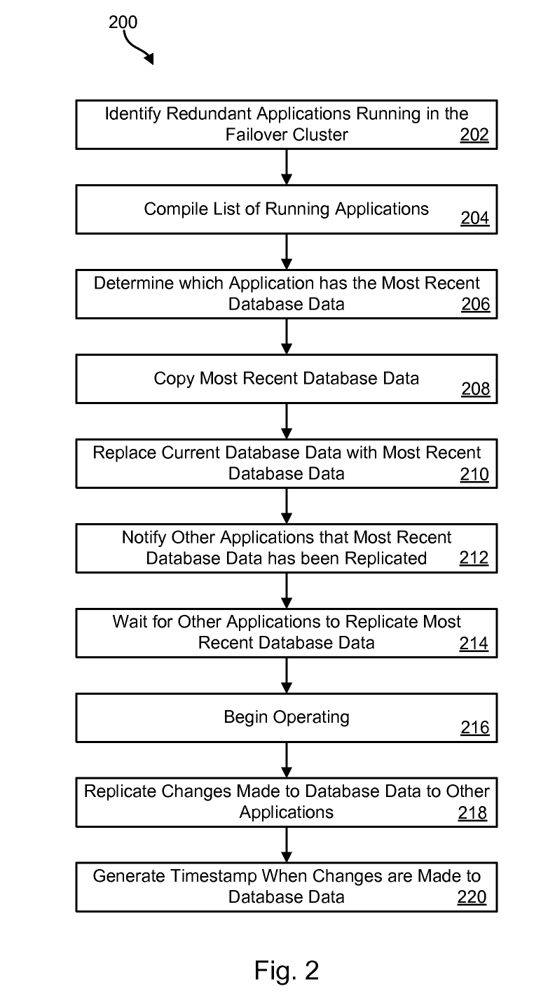

Referring to FIG. 2, in one embodiment, a method 200 implemented by a synchronization module 112 in accordance with the invention may include initially identifying 202, upon startup of an application 106, other redundant applications 106 running in a failover cluster 102. This step may be accomplished, for example, by attempting to communicate with other applications 106, such as by way of a TCP/IP connection. The synchronization module 112 may then compile 204 a list of redundant applications 106 that are up and running. With this list, the synchronization module 112 may communicate with each application 106 in the list to determine 206 which application 106 has the most recent data in its embedded database 108. This step 206 may include, for example, comparing timestamps associated with the database data of each application to determine which timestamp is the most recent.

Once the most recent database data is identified, the synchronization module 112 may then copy 208 the data and replace 210 the application's database data (i.e., the database data of the application associated with the synchronization module 112) with the most recent data. At this point, the synchronization module 112 may then notify 212 other applications 106 in the cluster 102 that the data has been copied by providing a ready signal. The synchronization module 112 may also wait 214 for a ready signal from each of the other applications 106 in the cluster 102 indicating that they have also updated their database data with the most recent data. In certain embodiments, system notifications may be generated if any error conditions are generated during this process.

Once the most recent database data is replicated by each application 106 in the cluster 102, each application 106 may begin operating 216 (e.g., processing service requests, etc.). While operating, the synchronization module 112 of each application 106 may replicate 218 changes made to its embedded database 108 to the embedded databases 108 of other applications 106 in the cluster 102. The applications 106 may also generate 220 a timestamp each time changes are made to their respective embedded databases 108. These timestamps may be used by the applications 106 upon startup to determine which of the applications 106 stores the most recent database data in the event one or more of the applications 106 unexpectedly shuts down or crashes.

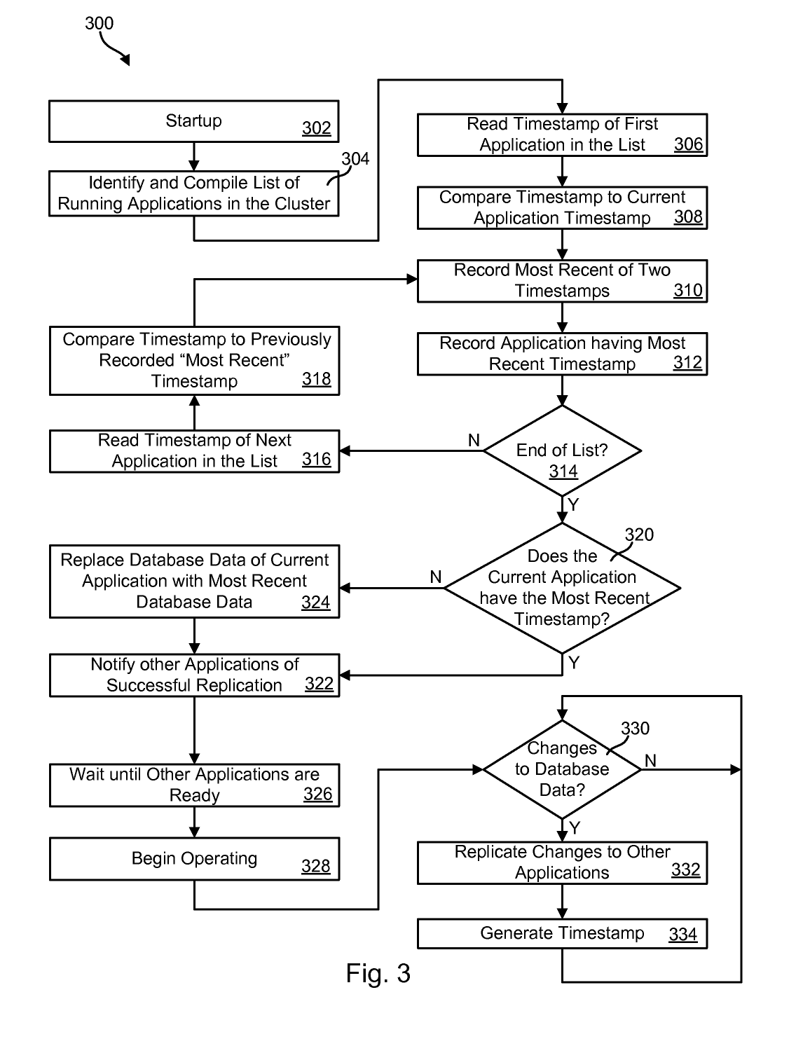

Referring to FIG. 3, one embodiment of a more detailed method 300 for synchronizing embedded databases 108 of applications 106 in a failover cluster 102 is illustrated. In this embodiment, a synchronization module 112 may, upon startup 302 of the application 106, identify 304 and compile 304 a list of redundant applications 106 running in the failover cluster 102.

The synchronization module 112 may then read 306 the timestamp of the first application 106 in the list and compare 308 this timestamp with the timestamp of the current application (i.e., the application 106 associated with the synchronization module 112). The synchronization module 112 may then record 310 the most recent of the two timestamps and record 312 the name or identity of the application 106 associated with the most recent of the two timestamps. If, at a decision step 314, there are additional applications 106 on the list, the synchronization module 112 may read 316 the timestamp of the next application on the list and compare 318 this timestamp with the timestamp previously recorded as the “most recent.” The synchronization module 112 may then record 310, 312 the most recent of the two timestamps and the identity of the application 106 associated with the most recent timestamp. These steps 316, 318, 310, 312 may be repeated for each application 106 in the list.

Once the end of the list is reached, the synchronization module 112 may then check, at a decision step 320, whether the most recent timestamp corresponds to the current application. If the most recent timestamp does not correspond to the current application, the synchronization module 112 may replace 324 the database data of the current application with the database data identified as the most recent. This may include copying the database data from the application 106 storing the most recent data. If, on the other hand, the most recent timestamp does correspond to the current application, the synchronization module 112 may simply proceed to the next step 322 since the current application already stores the most recent data.

Once the synchronization module 112 verifies that the current application stores the most recent data, the synchronization module 112 may then notify 322 other applications that it has successfully replicated the most recent database data by providing a ready signal to the other applications 106. Similarly, the synchronization module 112 may wait 326 until other applications 106 have replicated the most recent data. This may be accomplished, for example, by waiting 326 for a ready signal from the other applications 106. Once the database data has been replicated by all running applications 106 in the cluster 102, the applications 106 may begin operating 328.

While operating, each application 106 may monitor changes that are made to the data in its embedded database, as indicated by the decision step 330. If changes are made, these changes may be replicated 332 to the embedded databases of other applications 106 in the cluster 102. Additionally, a timestamp may be generated 334 each time these changes occur. In the event an application 106 shuts down or crashes, this timestamp may be used at startup to determine which application 106 stores the most recent data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for synchronizing embedded databases of applications in a failover: cluster, the method comprising:
identifying, by an application upon startup, redundant applications running in a failover cluster, wherein each of the application and redundant applications comprises an embedded database;
determining which embedded database of the application and redundant applications contains the most recent version of data;
retrieving the most recent version of data;
writing the most recent version to the embedded database of the application;
notifying the redundant applications that the most recent version has been written to the embedded database of the application;
waiting for the redundant applications to write the most recent version to their respective embedded databases;
commencing operation, by the application, after notifying the redundant applications and waiting for the redundant applications;
replicating, while the application is operating, changes made to the embedded database of the application to the embedded databases of the redundant applications; and
generating, by the application while operating, a timestamp indicating the time the changes were made to the embedded database of the application.

2. The method of claim 1, wherein determining further comprises comparing timestamps of the embedded databases of the application and redundant applications to determine which embedded database contains the most recent version of data.

3. The method of claim 1, wherein identifying further comprises compiling a list of redundant applications running in the failover cluster.

4. A computer program product to synchronize embedded databases of applications in a failover cluster, the program product comprising a computer-readable medium storing a computer-readable program that when executed on a computer causes the computer to:
identify, by an application upon startup, redundant applications running in a failover cluster, wherein each of the application and redundant applications comprises an embedded database;
determine which embedded database of the application and redundant applications contains the most recent version of data;
retrieve the most recent version of data;
write the most recent version to the embedded database of the application;
notify the redundant applications that the most recent version has been written to the embedded database of the application;
wait for the redundant applications to write the most recent version to their respective embedded databases;
commence operation, by the application, after notifying the redundant applications and waiting for the redundant applications;
replicate, while the application is operating, changes made to the embedded database of the application to the embedded databases of the redundant applications; and
generate, by the application while operating, a timestamp corresponding to the time the changes are made to the embedded database of the application.

5. The computer program product of claim 4, wherein determining further comprises comparing timestamps of the embedded databases of the application and redundant applications to determine which embedded database contains the most recent version of data.

6. The computer program product of claim 4, wherein identifying further comprises compiling a list of redundant applications running in the failover cluster.
